(19) United States
(12) Patent Application Publication
(10) Pub. No.: US 2013/0006803 A1
(43) Pub. Date: Jan. 3, 2013

(54) ITEM SOURCE OF ORIGIN STAMP

(75) Inventors: Ilya Oskolkov, Moscow (RU); Artem Kirakosyan, St. Petersburg (RU); Rodion Shishkov, St. Petersburg (RU); Igor Sokolov, Tver (RU)

(73) Assignee: Rawllin International Inc.

(21) Appl. No.: 13/174,956

(22) Filed: Jul. 1, 2011

(51) Int. Cl. G06Q 30/00

(52) U.S. Cl. 705/26.8

(57) ABSTRACT

Disclosed are electronic systems and techniques for implementing lists that include source of origin information for items added to the lists. A portal can include a component that enables items to be added to lists associated with the portal from a variety of sources, such as social networks, other portals, advertisements, search engines, other users, etc. In this regard, the items can be added to a list with references to the portal, instead of the source of origin, and information relating to the source of origin can be maintained to assist users in future prioritizations of items included in the list.

### TECHNICAL FIELD

The subject application relates to electronic commerce, and, more particularly, to maintaining source of origin data with items included in electronic lists.

### BACKGROUND

Presently, many users of network applications and services have had experiences with or are familiar with the concept and use of wish list applications and services that provide a user a mechanism to temporarily store online references to items or item links, e.g., goods, services, offers, etc., prior to purchasing these items, and that provide item references to others so that such others may purchase the items as a gift for the user. A conventional wish list schema is directed to a user visiting a shopping web site and selecting an item to purchase where, for a variety of reasons, the user may desire to postpone the immediate purchase of the item. The user may choose to create a wish list associated with a particular shopping site and add the items to that wish list, e.g., items that users desire.

Additionally, presently, items, which users may find of interest and subsequently add to their wish lists could be discovered and directly added from within shopping portals various tools, such as search, recommendations, promotions, etc. and also at third party online and off line spaces, such as through search engines, social networks, through friends' recommendations, through online advertisements and by capturing barcodes via offline banners and advertisements. Thus, the user may gather an extensive list of items in their wish list. After a period of time user may forget the details of the item description or why one or the other item was included into the wish list.

Moreover, in order to add an item to the user's wish list in these conventional applications, an item needs to be found in and selected from a particular website. Items discovered at third party online sources cannot be added directly to the wish list. For example, an Internet user who learns of a product at a third party website must first navigate to the site where the user's wish list resides, and then search for that item again. Only then can the user add the found item to the user's wish list, creating an inconvenient experience to say the least.

Furthermore, typical pre-shopping applications do not allow the user to save product description tags, which may assist a user in selecting the best items in the item lists for later purchase. Such tags may be references to general product categories, manufacturers, names of friends who recommended the item or friends who already own the product of interest, the product's popularity ranking, product reviews, and notifications of the product's related activities. In essence, a typical shopping scenario today consists of a user looking to buy a product, conducting product research at various online and off line sources, and then visiting shopping sites to find and purchase a product. Such systems are not flexible and give users limited options for shopping for and selecting items at different websites.

The above-described deficiencies of today's online shopping systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for list systems that incorporate source of origin information are contained herein. An exemplary system includes a list component, associated with a portal, configured to maintain a set of items in a list associated with a first user, an interface component configured to obtain data related to an item for inclusion in the set of items from at least one source, wherein the list component is further configured to locate the item in the portal based at least in part on the data, and an origin component configured to append source data to the item that identifies the at least one source from which the data related to the item was obtained.

In another non-limiting embodiment, an exemplary method is provided that includes the steps of obtaining information related to an item from at least one source, correlating the information related to the item to an item reference associated with a portal, attaching an identifier of the at least one source from which the information was obtained to the item reference, and storing the item reference in a list associated with a first user.

In still another non-limiting embodiment, an exemplary computer readable storage medium is provided that includes computer executable instructions that, in response to execution by a computing system, cause the computing system to perform operations, including obtaining information related to an item from at least one source, locating an item reference for the item associated with a portal based at least in part on the information, adding the item reference to a list associated with a first user, and maintaining an identifier of the at least one source from which the information was obtained with the item reference.

In yet another non-limiting embodiment, a exemplary system is provided that includes means for obtaining information related to an item from at least one source, means for locating an item reference for the item associated with a portal based at least in part on the information, means for adding the item reference to a list associated with a first user, and means for maintaining an identifier of the at least one source from which the information was obtained with the item reference.

In another non-limiting embodiment, an exemplary device includes a capture component configured to obtain information related to an item, a source component configured to identify a source of the information obtained, an identification component configured to obtain a reference for the item with relation to a portal based at least in part on the information, and an update component configured to enable a user to add the reference for the item to a list associated with the portal.

In still another non-limiting embodiment, an exemplary method is provided that includes the steps of acquiring data related to an item, identifying a source of the data acquired, obtaining an item link based on the data, wherein the item link references a portal, and instructing the portal to add the item link to a list associated with portal.

These and other embodiments are described in more detail below.

### BRIEF DESCRIPTION OF DRAWINGS

FIG. 1 illustrated is an example list system;

FIG. 2 illustrated is an example list system in accordance with various aspects described herein;

FIG. 3 illustrated is an example list component in accordance with various aspects described herein;

FIG. 4 illustrates an example social graph in accordance with various aspects described herein;

FIG. 5 illustrates an example wish list software application in accordance with various aspects described herein;

FIG. 6 illustrates an example wish list software application in accordance with various aspects described herein;

FIG. 7 illustrates an example user device in accordance with various aspects described herein;

FIG. 8 illustrates an example wish list viewing pane in accordance with various aspects described herein;

FIG. 9 an example brief item description in accordance with various aspects described herein;

FIG. 10 illustrates an example item playback in accordance with various aspects described herein;

FIG. 11 illustrates an example source of origin in accordance with various aspects described herein;

FIG. 12 illustrates an example purchase event in accordance with various aspects described herein;

FIG. 13 is a flow diagram showing an exemplary non-limiting implementation for list management;

FIG. 14 is a flow diagram showing an exemplary non-limiting implementation for maintaining source of origin information

FIG. 15 is a block diagram representing exemplary non-limiting networked environments in which various non-limiting embodiments described herein can be implemented; and

FIG. 16 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

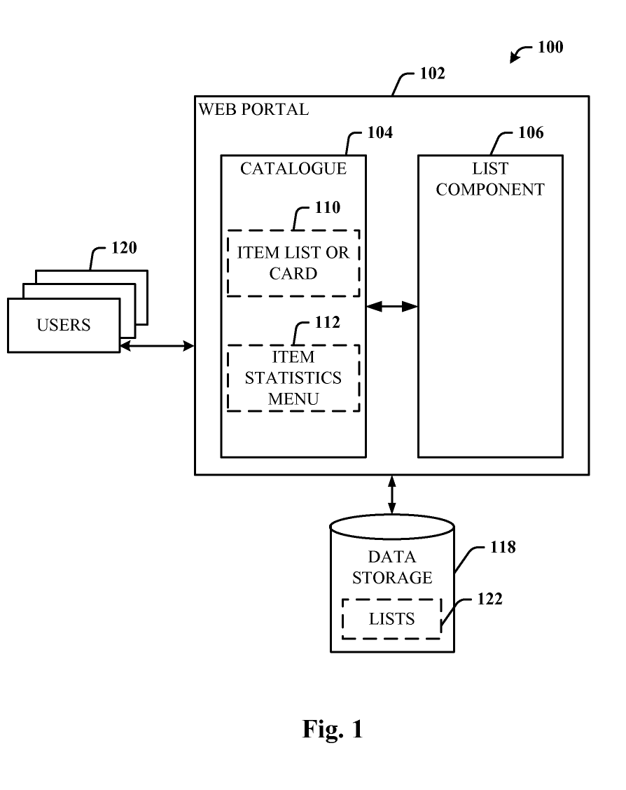

Referring initially to FIG. 1, illustrated is an example list system 100 in accordance with various aspects described herein. The list system 100 includes a web portal (e.g., web shopping portal, portal, etc.) 102, having an item catalogue (e.g., product catalogue, item database, etc.) 104 and a list component (e.g., wish list component) 106. The item catalogue 104 is an area of the web portal 102 where a user 120 can search for items to purchase, research, or otherwise view. The item catalogue 104 includes an item list or card 110 and an item statistics menu 112. The item list 110 displays a collection of items based on one or more criteria. For example, the item list 110 can display a collection of items in response to a user query for a keyword or item description (e.g., title, category, etc.). In addition, the item list 110 can display a collection of items generated by the web portal based on a current sale, promotion, inferred user interest, and so forth. It is to be appreciated that the foregoing are merely examples, and the item list 110 can display a collection of items based on virtually any criteria. Additionally or alternatively, the catalogue 104 can display an item card (e.g., item card) 110. For instance, when the user 120 selects or clicks on any item in any of the displayed lists in the catalogue 104, an item description page, referred to herein as an item card 110 can be displayed. The item statistics menu 112 can display or track one or more statistics associated with an item, including but not limited to, ratings, reviews, purchases, inventory, life span, technical details, etc.

The list component 106 enables users to temporarily store online references to items or item links (e.g., goods, digital goods, services, offers, etc.) in a list 122, prior to purchasing, viewing, or otherwise acquiring these items. Typically, a list schema is directed to a user visiting a shopping web site, such as portal 102, and selecting an item to purchase from a catalogue 104 or item list 110 where, for a variety of reasons, the user 120 may desire to postpone the immediate purchase of the item. The user 120 may choose to create a list (e.g., wish list) 122 associated with a particular shopping site, and add the desired items to that list 122. The list 122 can be maintained in a data storage 118 associated with the list system 100. It is to be appreciated that the data storage 118 can be internal or external. It is to be further appreciated that the exemplary list system 100 is described as a wish list with reference to a commercial shopping system for simplicity of explanation; however, the system 100 can be applied to virtually any list system, including non-commercial systems. For example, the list system can additionally or alternatively be an academic list system that includes an academic list component that enables users to store online references to items or item links, such as academic journals, research papers, websites, and so forth.

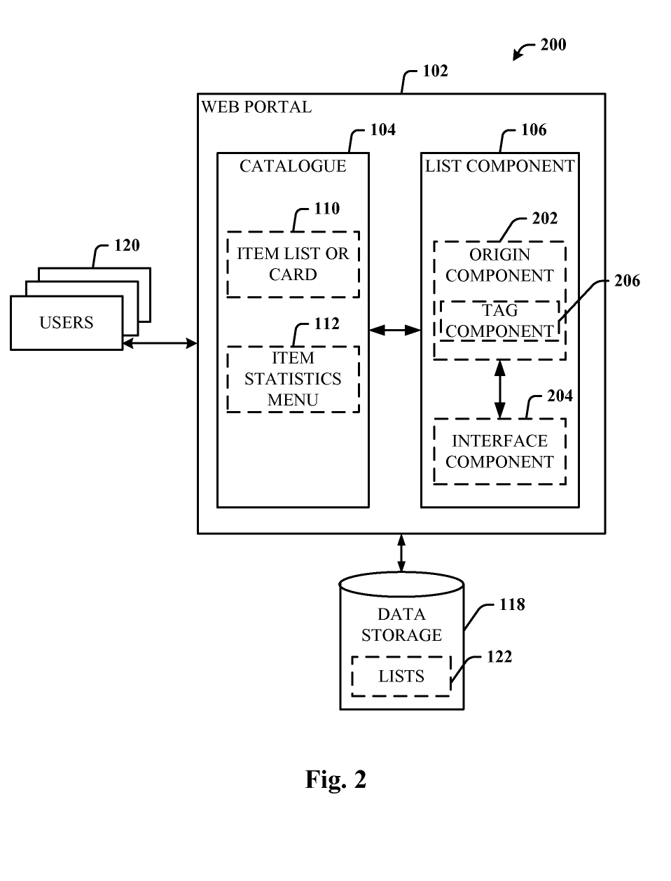

Turning to FIG. 2, illustrated is an example list system 200 in accordance with various aspects described herein. The list system 200 includes a web portal 102, having a catalogue 104 and a list component 106. As discussed previously, the catalogue 104 is an area of the web portal 102 where a user 120 can search for products to purchase, research, or otherwise view, and includes an item list or card 110 and an item statistics menu 112. For example, items included in the catalogue 104 can include streaming multimedia products, such as movies, videos, or films, wherein the user 120 can browse for a particular title or genre of movie, and select a movie that they may desire to view.

The list component 106 enables users to temporarily store online references to items or item links (e.g., goods, services, offers, etc.) in a list 122, prior to purchasing these items. For example, the user 120 may locate a movie via the catalogue 104, and wish to postpone purchasing the movie until they have some free time to view the movie. In addition, the list 122 can provide item references to others, so that others can purchase the items as a gift for the user 120, or get recommendations based on the user's 120 list.

In one embodiment, the list component 106 includes an origin component 202, and an interface component 204. The origin component 202 tracks, ascertains, or otherwise determines a source of origin for an item added to the user's 120 list 122, and associates, maintains, or otherwise links information relating to the source of origin with the item. For example, the user 120 can add an item to their list directly from the catalogue 104, wherein the origin component 202 can determine that the user 120 added the item from the catalog 104, and associate an indicator with the item identifying the item's source of origin as being added by the user from the catalogue 104. Additionally or alternatively, an item can be added to the user's 120 list using a plurality of techniques, including but not limited to from a friend of the user, from a social networking website, via a search engine result, from an online advertisement, from an offline advertisement, from a barcode scan, from another portal, from a data matrix scan, from a photograph, etc.

In addition, the origin component 202 can include a tag component 206 that enables the user 120 to manually enter and save description tags to an item included in the list, which may assist the user 120 in selecting the best items in the list for later purchase. Such tags may be references to categories, manufacturers, names of friends or associates who recommended the item or friends who already own the item of interest, the item's popularity ranking, item reviews, and notifications of the item's related activities. For example, the user 120 may have added an item to their list 122 based on a recommendation from an instructor and the tag component 206 can enable the user 120 to save a description tag, such as “My law professor recommended that I read this law review article—follow up with him after reading.”

The interface component 204 includes any suitable and/or necessary adapters, connectors, channels, communication paths, etc. to integrate the list component 106 into virtually any operating, communication, and/or database system(s). Moreover, the interface component 204 can provide various adapters, connectors, channels, communication paths, etc., that provide for interaction with the system 200. For example, the interface component 204 can enable the list component 106 to receive, obtain, or otherwise acquire items from outside of the portal 102, such as from a social networking website (e.g., Face book, Twitter, or LinkedIn), etc. to include in the user's 120 list 122.

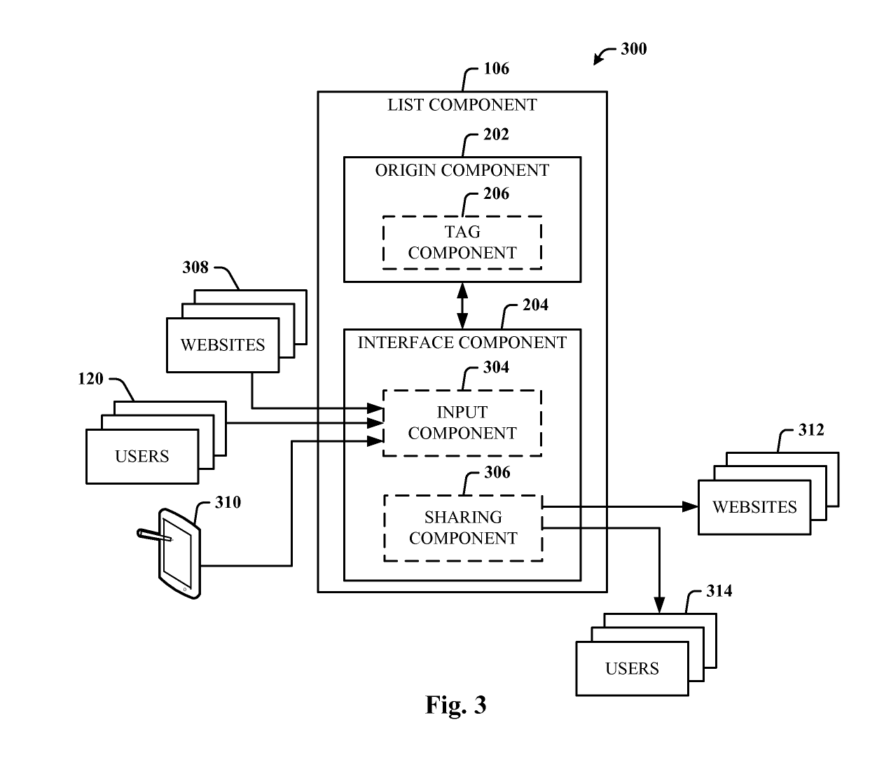

Referring now to FIG. 3, illustrated is an example list component 106 in accordance with various aspects described herein. The list component 106 includes an origin component 202, and an interface component 204. As discussed previously, the list component 106 enables users 120 to store, save, or otherwise maintain a list of items (e.g., a wish list, item list, etc.) that users 120 find of interest, but for a variety of reasons desire to postpone immediately purchasing, viewing or otherwise acquiring. In addition, the origin component 202 tracks, ascertains, or otherwise determines a source of origin for an item added to the user's 120 list, and associates, maintains, or otherwise links information relating to the source of origin with the item. Items can be added to a list via a plurality of means, including but not limited to from a catalogue included in an associated portal, by a friend of the user 120A, a social networking website, a search engine result, an online advertisement, an offline advertisement, a barcode scan, another portal, a data matrix scan, a photograph, etc.

The interface component 204 includes an input component 304 and a sharing component 306. The input component 304 includes any suitable and/or necessary adapters, connectors, channels, communication paths, etc. to enable the list component 106 to receive, acquire, otherwise obtain items to be added to a list from virtually any operating, communication, and/or database system(s). For example, the input component 304 can facilitate receiving information related to items to be included in a list from other websites 308, such as social networking websites, disparate portals, internet advertisements, message boards, chat rooms, application markets, etc. Moreover, the input component 304 can enable other users 120 to include items in a friend's list, or include items purchased by other users 120 on a friend's list. For instance, two friends, user A and user B, may enjoy similar movies. So, if user A purchases a new movie, then the new movie can also be placed on user B's list.

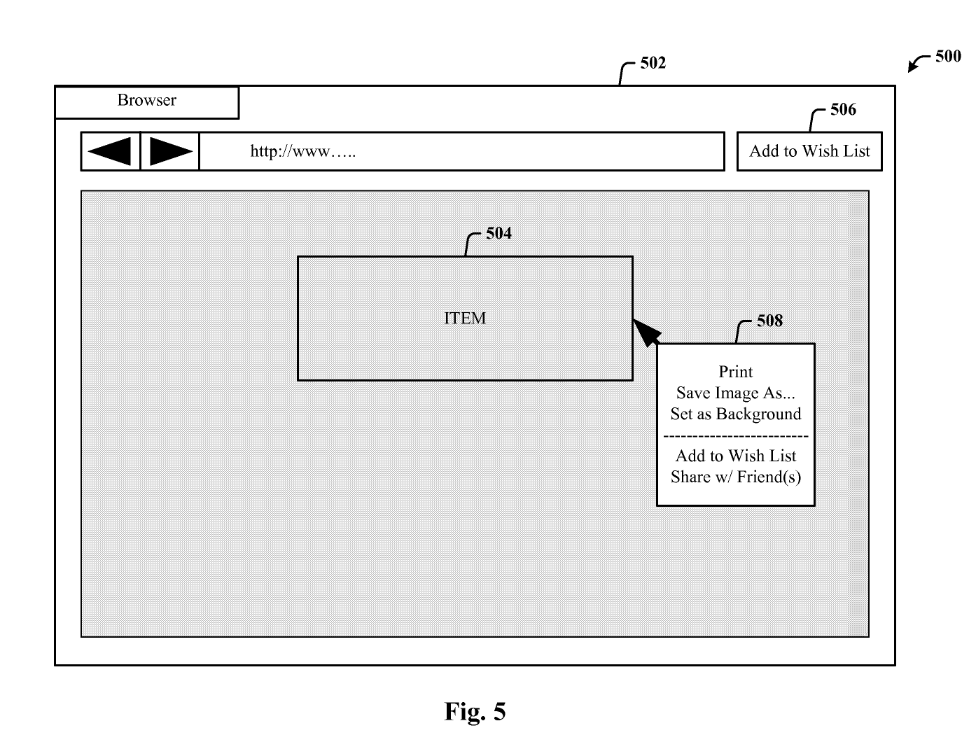

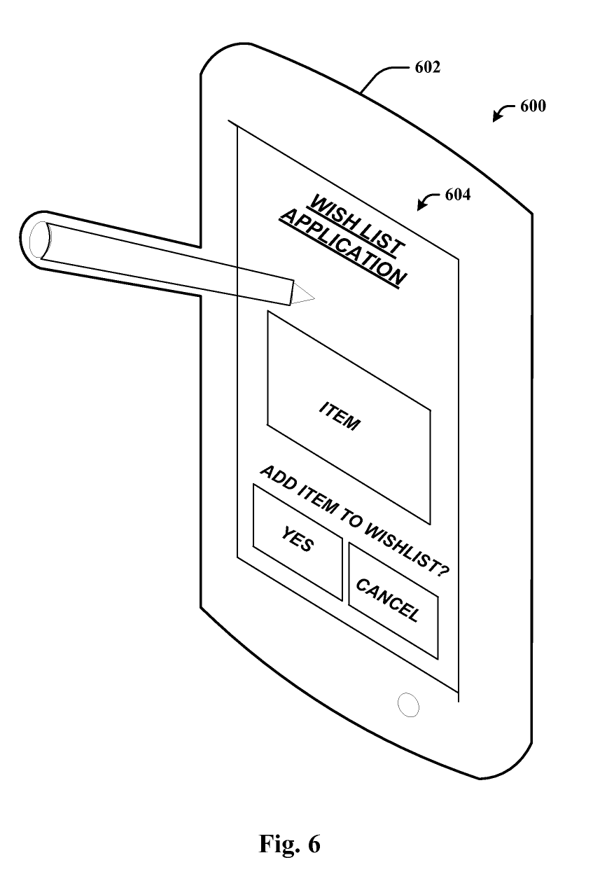

A software application associated with the list component 106, or including one or more features of the list component 106, can be downloaded to a user computer or device, or accessed online via a network connection, to facilitate adding items to a list via other websites 308 (See FIGS. 5 and 6). The user device 310 can include, but is not limited to, a tablet, a personal digital assistant (PDA), a cell phone, a smart phone, a gaming system, a digital camera, a streaming media device, a portable music player, or an internet-connected television. For example, a user may see an item at a retail store, and using a smart phone scan the barcode associated with the item to add it to their list. As an additional example, a user may photograph a billboard advertising an item that the user desires, and communicate the photograph to the list component 106 in order to add the item to their list, wherein the list component 106 can identify the desired item based on the photograph, and add the item to the user's list.

The sharing component 306 includes any suitable and/or necessary adapters, connectors, channels, communication paths, etc. to enable the list component 106 to distribute, broadcast, or otherwise share one or more items on a user's list to other websites 312, or users 314. For example, the user may desire to share one or more items on their list via a social networking website, such as Twitter or Facebook, or a user may desire to share their list with a set of users associated with the portal (See FIG. 2), or with another user via email.

The origin component 202 can determine a source of origin for an item added to the user's list from an external source (e.g., other users, websites, user devices, etc.) via the interface component 204, and annotate, maintain, or otherwise associate an indicator with the item identifying the item's source of origin. The source of origin (e.g., history of origin) is the name of the source from which an item was added to the user's list. This feature can assist a user in determining the value of the selection, or help credit other users for recommending an item. For example, if an item was added by a close friend, it may be more highly regarded by a user compared to a random selection by the system or a recommendation by an unknown user, and thus the system may help users make a better purchasing decision based on the source of product discovery. As an additional example, if the items included in the list pertain to a research project, then an item obtained from an academic journal may be more useful than an item obtained from an internet website. Thus the history of origin may be the name of a social network, name of an online search engine, a source, a friend's name, and the like. As discussed previously, the origin component can also include a tag component 206 that enables users 120 to manually enter and save description tags to an item included in the list, which may assist the user 120 in selecting the most preferred items in the wish list for later purchase.

In various embodiments described herein, reference is made with respect to a user's “social presence” or to a user's “friends” or a “social network.” It is to be noted that such terms are used in an online context to generally to refer to an underlying social graph.

A social graph can be described as data structure(s) representing the global mapping of everybody and how they're related. Online social networks can exploit social graphs by examining the relationships between individuals to offer a richer online experience. The term can be used to refer to an individual's social graph, e.g., the connections and relationships pertinent to that individual, or the term can also refer to all Internet users and their complex relationships.

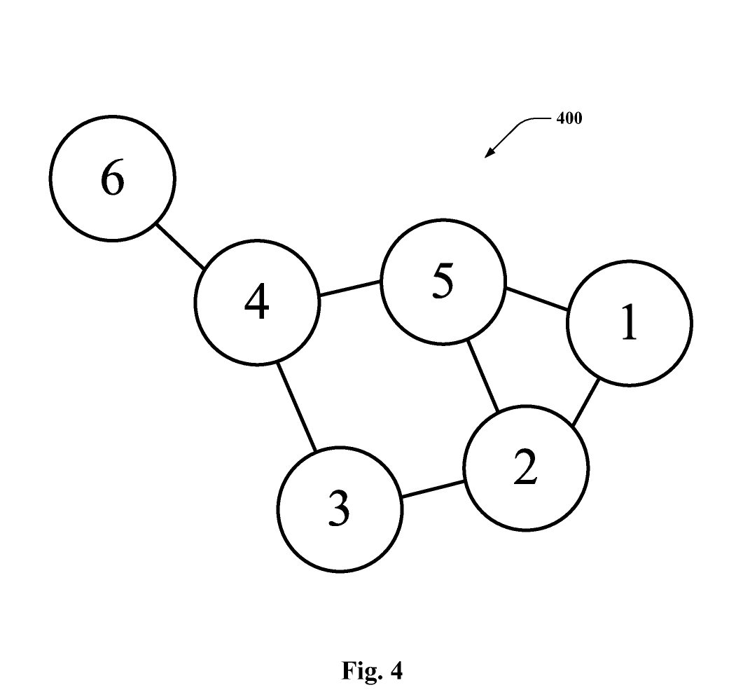

In this regard, while a graph is an abstract concept used in discrete mathematics, a social graph describes the relationships between individuals online, e.g., a representation or description of relationships in the real world. A social graph is a socio-gram that represents personal relations. In this regard, a social graph is a data representation, and can be defined explicitly by its associated connections, and stored in or across computer memories. Social graph information can be exposed to websites, applications and services in order to take advantage of the information (e.g., demographic information) embodied by the graph information and associated data and metadata about the individuals comprising the graph. For example, in FIG. 4, social graph 400 illustrates a set of example interconnected members 1, 2, 3, 4, 5 and 6, and their respective relationships.

The concept of a social graph is not limited to just interconnections of people, but rather websites, applications and services can draw information about various objects and information, e.g., photos, audio, events, web pages, etc. and their relationships. The social graph concept can be expanded to more than just relationships between individuals, and can apply to virtual nonhuman objects between individuals, as well.

Thus in various embodiments described herein, each service member can be allocated a personal social space associated with one or more wish lists. The personal social space can include list of user virtual friends, which allows users to view the content of their friends' wish lists, to view the list of items recommended by the user friends, to search for new items of interest based on friends' comments and dislikes per personal user context, view the list of friends' social activities, and so on. For instance, the following activity types are considered as social: an item is purchased by a service member's friend, an item is rated by a service member's friend, an item is favored by a service member's friend, etc., though by no means is the foregoing list inclusive or exhaustive as many other activities can be considered social. Further, the user may select items of interest to preview, to add to their own wish list, to purchase, and so forth.

Social data can be homegrown, sourced from third parties, or a combination thereof. For instance, third party social networks and other online spaces where user interaction is permitted can be leveraged for social mapping information related to a given social graph, such as discussion forums, fan sites, news sites, online product databases, online recommendation and references sites, dictionaries, wikis, user blogs', search engines, decision guides, search engines, social network services, etc. Information exchange with social networks can be facilitated via the interface component 204 (See FIG. 3), or implemented through open authorization protocol depending on the social network related functionality, to allow standard and secure application programming interface (API) multi-domain authentication and authorization without exposing the user's credentials. Thus, optionally, visitors/users may login into the system using their social network accounts or other sources of social data. Additionally, the various embodiments for the above-described wish list services may import from personal user context data, user friends list, and aggregated user context data from third party social networks. Furthermore, notifications of user social activities can be posted at the user's social network personal space, and thus the communication with such third-party social network services can be bi-directional, benefitting both systems with additional input. Such interaction provides an opportunity of expanding target audiences beyond a given set of members and allows an opportunity to send communications to third party social network friends (e.g., invitations to third party social network friends, personal or common, to join the service).

Also, the wish list need not be considered a flat structure. The wish list may include multiple levels, e.g., hierarchical levels, some of which may be categorized by the user-owner of the wish list who has ultimate authority of its control and maintenance. A user may categorize different portions of the wish list into areas for maintenance and/or display for different individuals, groups or subgroups. For example, in a social networking environment, a person may want to segregate different areas from various users, such as a parent wanting to show or otherwise share content or information to adult friends separately from children and young adults. A user may further want to separate items that the user chooses or submits into the user's wish list from items other users submit to the user's wish list. The user may also restrict or otherwise control submissions by certain or possibly all users into the user's wish list, and may even prohibit any submissions altogether.

In view of the example systems described supra, various exemplary embodiments that may be implemented in accordance with the disclosed subject matter may be better appreciated with reference to FIGS. 5-12. While for purposes of simplicity of explanation, the embodiments are shown and described as wish list systems with reference to a commercial shopping system, the subject matter can be applied to virtually any list system, including non-commercial systems.

Referring to FIG. 5, illustrated is an example wish list software application 500, in accordance with various aspects described herein. The wish list software application 500 can be downloaded from the shopping portal 102 (See FIG. 2), and installed at the user's computer, or user device (See FIGS. 3 and 5), in order to enable users to add items to their wish list at other web sites, including web sites not associated with the shopping portal 102 (e.g., non-partnering websites). Additionally or alternatively, the software application can be maintained online, wherein a user can access and execute the application, via a network connection, without having to install it on their computer or device.

As illustrated, the application 500 can be integrated into a web browser 502. The web browser 502 can enable retrieving, presenting, and traversing information resources on the World Wide Web, private networks, or in file systems. For example, a user can access a social networking website or shopping website using the web browser 502. The web browser 502 can allow integration of add-on applications, for example, via an application programming interface (API).

In operation, the user can visit a web page other than the shopping portal 102, and view one or more items 504 that the user desires to add to the wish list. The wish list software application 500 can enable the user to add virtually any item from virtually any website to their wish list. For example, the web browser 502 can include an “Add to Wish List” browser button 506 that when selected or clicked by the user will expose options relating to adding one or more items displayed on the current webpage to their wish list. The wish list software application 500 can extract and store product information relating to the desired item, connect with the shopping portal 102 (See FIG. 2), find the requested item in the products database (e.g., catalogue 104), and add the desired item to the user's wish list with reference to the shopping portal 102, and not the original source of discovery (e.g., current web page). The source or location where the item was found, can be maintained as the source of origin. For example, the user may have located a movie that they are interested in seeing via a movie review website, such as the Internet Movie Database (IMDB), and the wish list application 500 can include a note with the item in the wish list referencing IMDB as the source of origin. In addition, the wish list application 500 can expose a warning message to a user, if the user attempts to add an item that is already contained in their wish list, or if the wish list application 500 is unable to locate the item in the catalogue 104.

As an additional example, the wish list software application 500 can add additional menu items to a web browser 502 menu, such as a right-click menu 508, including but not limited to an “Add to Wish List” option, and a “Share w/ Friends” option. If the user selects the “Add to Wish List” menu option, then the wish list application 500 will automatically update the user's wish list with a reference to the item 504 in the shopping portal 102, without the user having to manually search for the item in the catalogue 104. Similarly, if the user selects the “Share w/ Friends” menu option, then the user can add the item to a friend's wish list, or share the item with a friend via a social networking website, email, etc. It is to be appreciated that the wish list software application 500 can be implemented in a plurality of ways, for example, the wish list software application 500 can be a separate or standalone software application.

FIG. 6 illustrates an example wish list software application 600 in accordance with various aspects described herein. As discussed previously, the wish list software application 600 can be a standalone software application for a computer or user device 602. The user device 602 can include but is not limited to a tablet, a personal digital assistant (PDA), a cell phone, a smart phone, a gaming system, a streaming media device, a portable music player, a digital camera, or an internet-connected television. The wish list software application 600 can be downloaded from the shopping portal 102 (See FIG. 2), a website, or an application market or store, and installed on the user device 602. Additionally or alternatively, the wish list software application 600 can be an online software application that can be accessed and executed via a network connection by a computer or the user device 602.

The wish list software application 600 can enable users to add items to their wish list via a plurality of input methods, including but not limited to social networking websites, search engine results, online advertisements, offline advertisements, barcode scans, other shopping portals, data matrix scans, photographs, or text messages. The wish list software application 600 can leverage functionality included on the computer or user device 602 to locate and add items to a user's wish list. For example, if the user device 602 includes a camera or bar code scanner, then the wish list application 600 can enable a user to capture a data matrix associated with an item that the user desires. Subsequently, the wish list software application 600 can extract and store product information relating to the desired item, connect with the shopping portal 102 (See FIG. 2), find the requested item in the products database (e.g., catalogue 104), and expose an “Add to Wish List” screen 604, that includes data relating to the item (e.g., picture, details, price, etc.), and an option to add the item to their wish list. If the user elects to add the item to their wish list, then the wish list software application 600 adds the desired item to the user's wish list with reference to the shopping portal 102, and maintains the original source of discovery (e.g., data matrix capture from magazine advertisement) as the source origin. In addition, a warning message can be exposed to a user, where the user attempts to add an item that is already contained in their wish list or cannot be located in the catalogue 104. In addition, the wish list software application 600 can present the user with an option to enter a brief description (e.g., a tag) to associate with the item, such as “I saw this product in my favorite magazine, and think it would make a super birthday gift.” It is to be appreciated that the wish list software application 500 can be implemented in a plurality of ways.

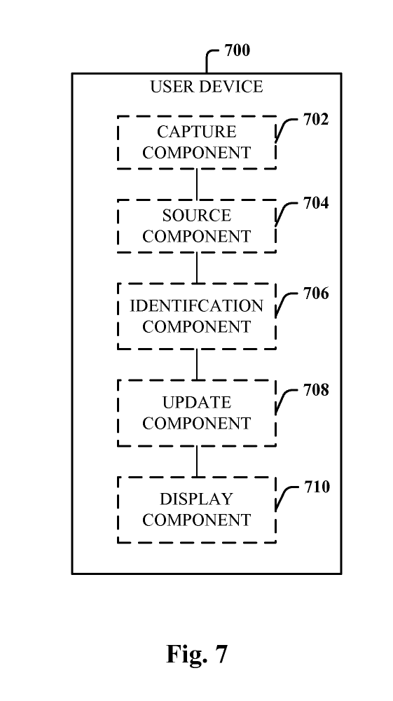

FIG. 7 illustrates an example user device 700 in accordance with various aspects described herein. The user device 700 can include but is not limited to a tablet, a personal digital assistant (PDA), a cell phone, a smart phone, a gaming system, a streaming media device, a portable music player, a digital camera, or an internet-connected television. The user device 700 includes a capture component 702, a source component 704, an identification component 706, an update component 708, and a display component 710. The capture component can obtain, acquire, or otherwise capture information relating to an item. The capture component 702 can employ one or more features of the user device 700, such as a touch screen, a keypad, a microphone, a camera, a barcode scanner, etc. to obtain the information. For example, the capture component 702 can employ a camera on the user device 700 to capture a data matrix included in a print advertisement for an item. In addition, the information relating to the item can include a plurality of data types, such as a photograph, a barcode, a data matrix, user input (e.g., title, keyword, etc.), a webpage, a text message, audio information (e.g., song, movie quote, etc.), or a search result.

The source component 704 can determine, ascertain, or otherwise identify a source from which the information relating to the item was obtained (e.g., source of origin). Continuing with the previous example, the source component 704 can identify the source as a data matrix included in a movie review magazine advertisement. Additionally or alternatively, the source component 704 can enable a user of the user device 700 to manually input the source of origin information, and/or one or more description tags. The identification component 706 can locate a reference to the item in a shopping portal, or a catalogue associated with the shopping portal. For example, the information may be the title of a movie, and the identification component 706 can locate the movie with reference to a shopping portal. Additionally or alternatively, the identification component 706 can communicate the information to the shopping portal, wherein the shopping portal locates the reference to the item, and communicates the reference to the identification component 706.

The update component 708 can enable the user of the device 700 to add the reference for the item to a wish list associated with the shopping portal. For example, the update component 708 can prompt the user whether to add the item to their wish list, and if the user selects to add the item, then the update component 708 can command the shopping portal to add the item to the user's wish list. Additionally or alternatively, the update component 708 can command the shopping portal to add the item to the user's wish list based on a set of predefined preferences. For example, the update component 708 can automatically instruct the shopping portal to add the item to the user's wish list based on the set of predefined preferences. The display component 710 can expose the item or item reference to the user of the user device 700, and/or prompts related to the capture component 702, the source component 704, identification component 706, or update component 708. For example, the display component 710 can display a graphical item reference (e.g., webpage, product card, etc.) to the user via a screen included on the user device 700, or the display component 710 can audibly communicate information regarding the item reference to the user via a speaker included on the device 700.

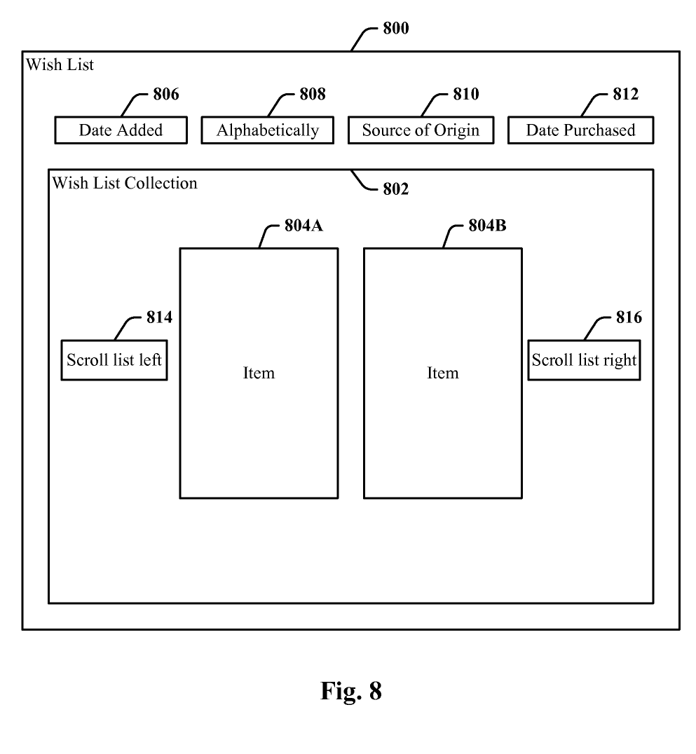

Turning to FIG. 8, illustrated is an example wish list viewing pane 800 is illustrated in accordance with various aspects described herein. The wish list viewing pane 800 includes a wish list collection 802 that displays a set of items 804 contained in a user's wish list. As discussed previously, users can store, save, or otherwise maintain items 804, or a link to items, that they find of interest, but for a variety of reasons desire to postpone immediately purchasing. It is to be appreciated that the wish list collection 802 is illustrated as containing only two items 804A and 804B; however, in practice the wish list collection 802 can include a virtually infinite number of items 804.

Items 804 in the wish list collection 802 can be sorted based on a variety of criteria. For example, the wish list viewing pane 800 can include a “Date Added” button 806 that enables a user to sort the items in the wish list based on the date (e.g., chronological or reverse chronological order) that the item was added to wish list collection 802. Additionally, the wish list viewing pane 800 can include an “Alphabetically” button 808 that enables users to sort the items in the wish list by name. In addition, the wish list viewing pane 800 can include a Source of Origin button 810 that enables users to sort the items 804 based on the source or origin. As discussed previously, the source of origin (e.g., history of origin) is the name of the source from which an item was added to the user's wish list. This feature can assist a user in determining the value of the selection, or help credit other users for recommending an item. For example, if an item was added by a close friend, it may be more highly regarded by a user compared to a random selection by the system or a recommendation by an unknown user, and thus the system may help users make a better purchasing decision based on the source of product discovery. Thus the history of origin may be the name of a social network, name of an online search engine, friend's name, and so forth. The wish list viewing pane 800 can further include a Date Purchased button 812 that can enable a user to sort items 804 in the wish list according to the date that they were purchased. For example, a user may desire to review items 804 in the wish list collection 802 that they have already purchased.

Moreover, the wish list viewing pane 800 can include functionality typically associated with a viewing pane or webpage, such as a scrolling, etc. For example, the wish list viewing pane 800 can include a Scroll List Left button 814, and a Scroll List Right button 816, that enable the user to scroll through the items 804 included in the wish list collection 802. Additionally or alternatively, the wish list viewing pane 800 can be adapted to accept touch inputs, such as swiping across a screen to scroll through the items 804 included in the wish list collection 802. It is to be appreciated that the foregoing represents but a few examples, and the wish list viewing pane 800 can be implemented in a plurality of ways.

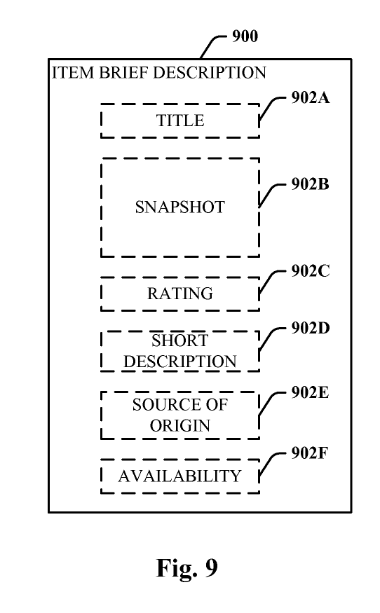

FIG. 9 illustrates an example brief item description 900 in accordance with various aspects described herein. The brief item description 900 provides a variety of information fields 902 relating to an item contained in a wish list. For instance, the brief item description 900 can be displayed in the wish list viewing pane 800, and can include a title field 902A that contains the name of the item, a snapshot field 902B that contains a photograph or picture of the item, and a rating field 902C that can include a product rating provided by a website, a shopping portal, a user, etc. In addition, the brief item description 900 can include a short description field 902D that provides information relating to the product, such as a brief explanation of the item, technical details related to the item, features, and so forth. Moreover, a source of origin field 902E included in the brief item description can contain the name of the source from which an item was added to the user's wish list. This feature can assist a user in determining the value of the selection, or help credit other users for recommending an item. Additionally, the brief product description 900 can include an item availability field 902F that can indicate whether the item is currently available for purchase, a quantity available, or a date of expected availability.

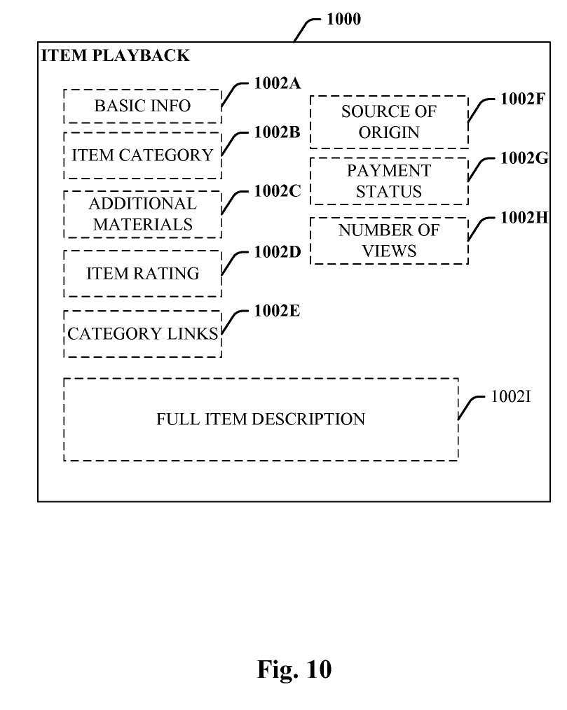

FIG. 10 illustrates an example item playback 1000 in accordance with an aspect of the subject innovation. As discussed previously, the item can be a multimedia file, such as a movie, film, video, song, etc. During playback of the item one or more data fields 1002 can be displayed or exposed to the user. The fields 1002 can include a basic info field 1002A that includes data relating to the release year of the item, the country of origin for the item, the title of the item, etc. In addition, the fields 1002 can include an item category field 1002B that details at least one group, class, or collection to which the item belongs. An additional materials field 1002C can be included in the fields 1000, and can contain images, trailers, samples, etc. of the item. The fields 1000 can further include a item rating field 1002D that can include an item rating from the shopping portal 102 (See FIG. 2), affiliated spaces, other shopping portals, websites, users, and so forth. A set of links to various categories related to the item can be provided in a category links field 1002E. Additionally, the fields 1002 can include a source of a origin field 1002 that identifies the location or person from which the item was originally added to a wish list. A payment status field 1002G can detail whether a payment has been received for an item or the type of payment received (e.g., purchased, rented, expired, etc.). The number of times that the item has been viewed can be displayed via a number of views field 1002H. In addition, a complete description of the item can be described via a full item description field 1002I. It is to be appreciated that only field 1002A-I are illustrated; however, the item playback 1000 can include a plurality of additional fields.

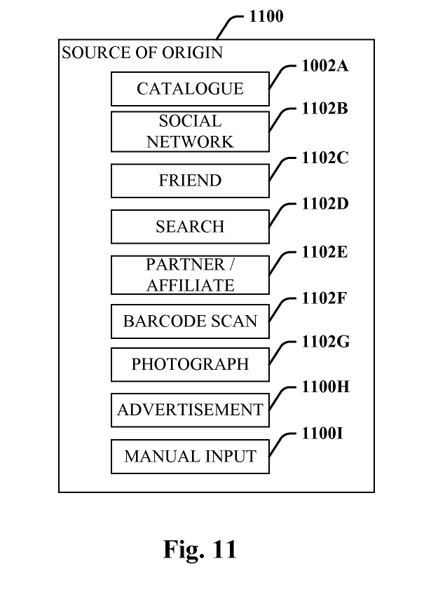

FIG. 11 illustrates an example source of origin 1100, in accordance with various aspects described herein. As discussed previously, the source of origin 1100 includes data relating to the history of an item's inclusion in a user's wish list. There a plurality of techniques 1102 that can be employed to add an item to the user's wish list. For example, the item can be added via a catalogue 1102. As mentioned in FIG. 2, a user can browse a catalogue included in a shopping portal, and an item to their wish list by selecting the item from the catalogue. In addition, items can be added a user's wish list via a social network 1102B, from a friend of the user 1102C, from a search engine query 1102D, from a partner or affiliate website 1102E, from a barcode (or data matrix) 1102F, from a photograph 1102G, from an advertisement (e.g., print, billboard, television, online, etc.) 11002H, or manually input 1102I by the user. It is to be appreciated that the source origin 1100 is illustrated as including techniques 1102A-I merely as examples for simplicity of explanation; however, a number of additional techniques are possible within the scope of the subject of the innovation.

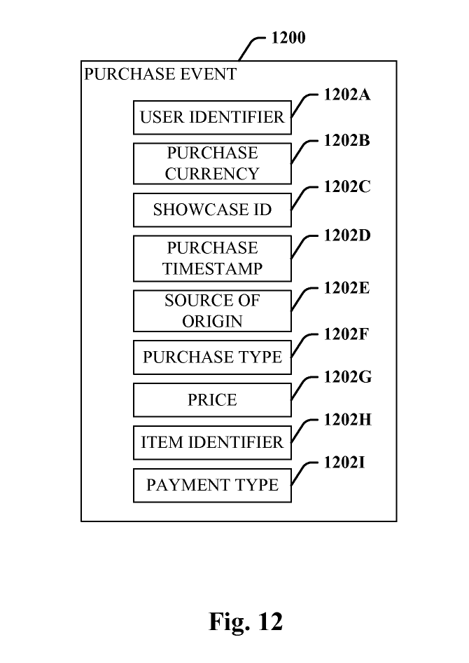

Turning now to FIG. 12, illustrated is an example set of fields 1202 that can be captured during a purchase event 1200. When an item is purchased from a user's wish list, by the user or someone wishing to gift the item to the user, it may be valuable to collect, track, or otherwise record information about the purchase event 1200. For example, a user identifier 1202A, a purchase currency 1202, a showcase identification (ID) 1202D, a purchase timestamp 1202F, a source of origin 1202E, a purchase type 1202F, a price 1202G paid for the item, an item identifier 1202H, and a payment type (e.g., rent, purchase, expire, etc.) 1202I can be recorded.

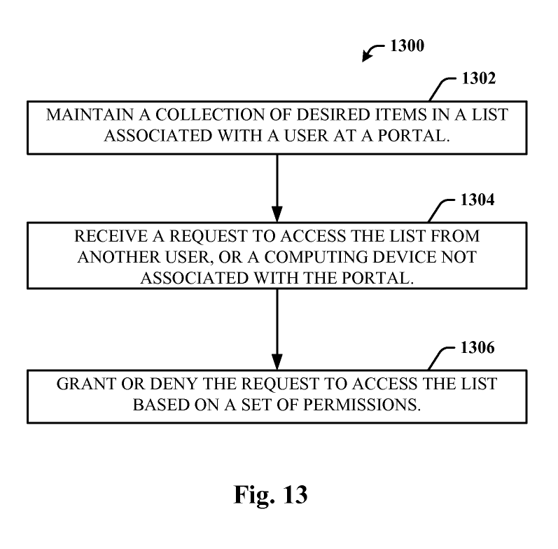

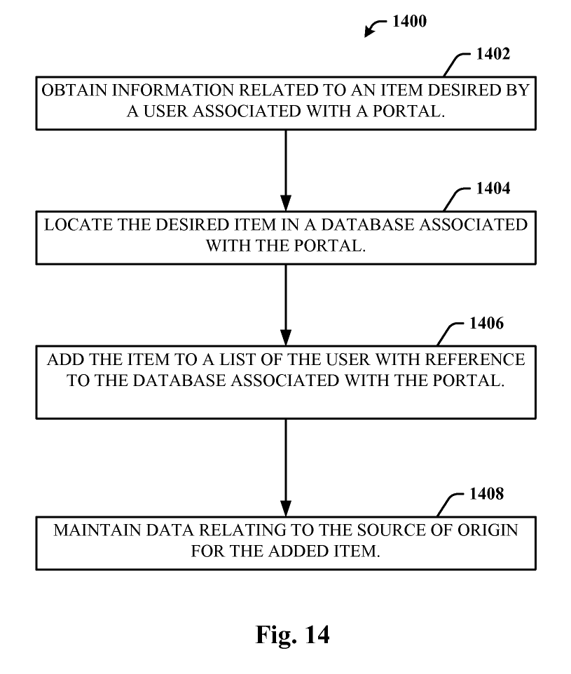

In view of the example systems described supra, methods that may be implemented in accordance with the disclosed subject matter may be better appreciated with reference to the flow charts of FIGS. 13-14. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 13, illustrated is an example methodology for list management 1300 in accordance with aspects described herein. Methodology 1300 can begin at block 1302, wherein a collection of desired items is maintained in a list associated with a user at a portal. For example, the portal can include a catalogue of streaming movies, and a user can save movies that they desire to view at a future time in the list. At 1304, a request to access the list from another user, or a computing device not associated with the portal is received. The list can be accessed to view, add or delete items contained therein from disparate websites, users (e.g., friends of the user), search engines, partner/affiliate websites, user devices, etc. For example, a friend of the user may desire to add a new movie to his or her friend's list, or may wish to purchase a movie from the friend's list as a gift. As an additional example, a social networking website may desire to update the user's list based on the user's activity. At 1306, a determination to grant or deny the request for access to the list is made based on a set of permissions for the user. For example, the user's permission may allow other users to access their list based on their status in a social graph associated with the user.

Turning now to FIG. 14, illustrated is an example methodology for maintaining source of origin information 1400 in accordance with aspects described herein. At 1402, information can be obtained relating to an item desired by a user associated with a portal. For example, a user may see a desired item at a retail store, and scan the barcode associated with the item, via a user device, and communicate the barcode to the portal to add the item to their list. At 1404, the desired item can be located in a database associated with the portal based at least in part on the information obtained in 1402. At 1406, the item can be added to a list of the user with reference to the database associated with the portal, and not the original source. For example, when the user views their list at the portal, the desired item will be displayed as a purchasable item at the portal instead of the original source. At 1408, data relating to the source of origin for the added item can be maintained with the item in the list. This feature can assist a user in determining the value of the selection, or help credit other users for recommending an item. For example, if an item was added by a close friend, it may be more highly regarded by a user compared to a random selection by the system or a recommendation by an unknown user, and thus the system may help users make a better prioritizing decision based on the source of discovery.

### Exemplary Networked and Distributed Environments

One of ordinary skill in the art can appreciate that the various non-limiting embodiments of the shared shopping systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

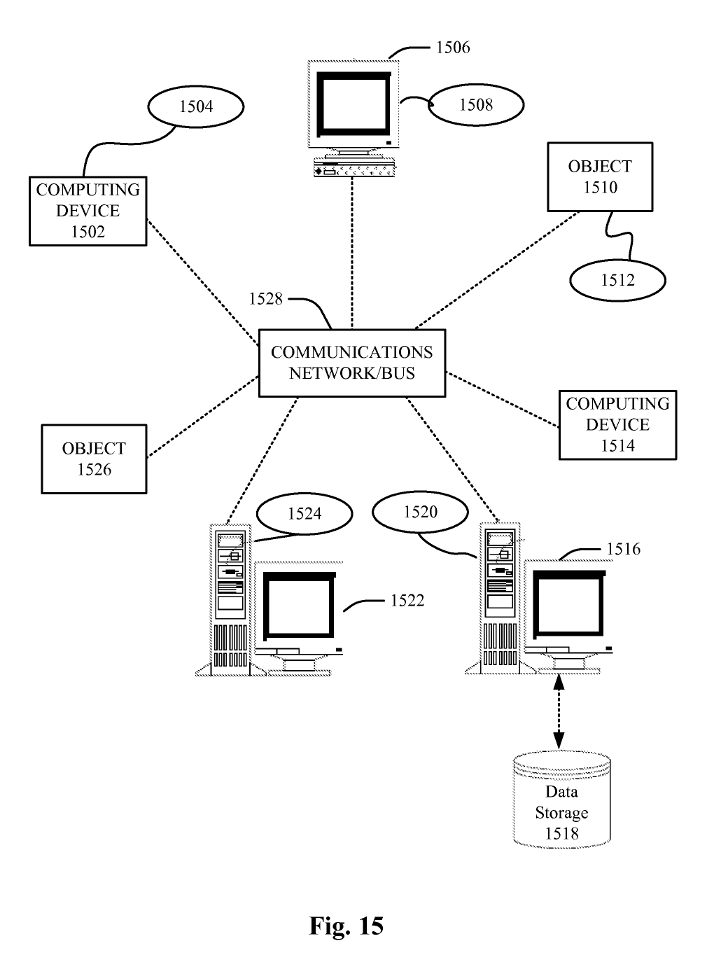

FIG. 15 provides a schematic diagram of an exemplary networked or distributed computing environment. The distributed computing environment comprises computing objects 1510, 1512, etc. and computing objects or devices 1520, 1522, 1524, 1526, 1528, etc., which may include programs, methods, data stores, programmable logic, etc., as represented by applications 1530, 1532, 1534, 1536, 1538. It can be appreciated that computing objects 1510, 1512, etc. and computing objects or devices 1520, 1522, 1524, 1526, 1528, etc. may comprise different devices, such as personal digital assistants (PDAs), audio/video devices, mobile phones, MP3 players, personal computers, laptops, etc.

Each computing object 1510, 1512, etc. and computing objects or devices 1520, 1522, 1524, 1526, 1528, etc. can communicate with one or more other computing objects 1510, 1512, etc. and computing objects or devices 1520, 1522, 1524, 1526, 1528, etc. by way of the communications network 1540, either directly or indirectly. Even though illustrated as a single element in FIG. 15, communications network 1540 may comprise other computing objects and computing devices that provide services to the system of FIG. 15, and/or may represent multiple interconnected networks, which are not shown. Each computing object 1510, 1512, etc. or computing object or device 1520, 1522, 1524, 1526, 1528, etc. can also contain an application, such as applications 1530, 1532, 1534, 1536, 1538, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 15, as a non-limiting example, computing objects or devices 1520, 1522, 1524, 1526, 1528, etc. can be thought of as clients and computing objects 1510, 1512, etc. can be thought of as servers where computing objects 1510, 1512, etc., acting as servers provide data services, such as receiving data from client computing objects or devices 1520, 1522, 1524, 1526, 1528, etc., storing of data, processing of data, transmitting data to client computing objects or devices 1520, 1522, 1524, 1526, 1528, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1540 or bus is the Internet, for example, the computing objects 1510, 1512, etc. can be Web servers with which other computing objects or devices 1520, 1522, 1524, 1526, 1528, etc. communicate via any of a number of known protocols, such as the hypertext transfer protocol (HTTP). Computing objects 1510, 1512, etc. acting as servers may also serve as clients, e.g., computing objects or devices 1520, 1522, 1524, 1526, 1528, etc., as may be characteristic of a distributed computing environment.

### Exemplary Computing Device

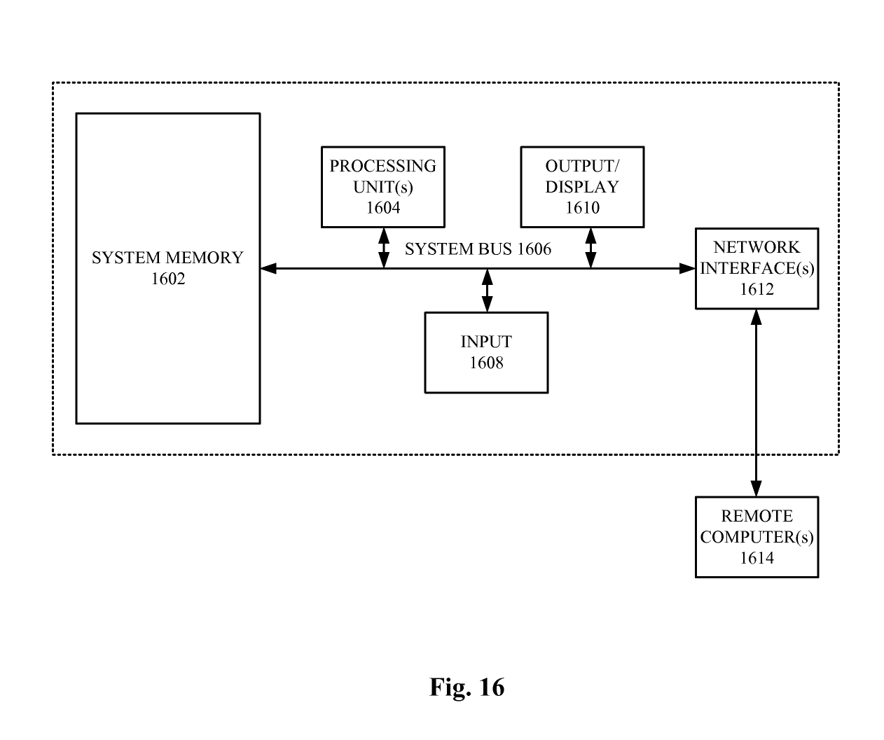

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 16 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 16 thus illustrates an example of a suitable computing system environment 1600 in which one or aspects of the non-limiting embodiments described herein can be implemented, although as made clear above, the computing system environment 1600 is only one example of a suitable computing environment and is not intended to suggest any limitation as to scope of use or functionality. Neither should the computing system environment 1600 be interpreted as having any dependency or requirement relating to any one or combination of components illustrated in the exemplary computing system environment 1600.

With reference to FIG. 16, an exemplary remote device for implementing one or more non-limiting embodiments includes a general purpose computing device in the form of a computer 1610. Components of computer 1610 may include, but are not limited to, a processing unit 1620, a system memory 1630, and a system bus 1622 that couples various system components including the system memory to the processing unit 1620.

Computer 1610 typically includes a variety of computer readable media and can be any available media that can be accessed by computer 1610. The system memory 1630 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1630 may also include an operating system, application programs, other program modules, and program data.

A user can enter commands and information into the computer 1610 through input devices 1640. A monitor or other type of display device is also connected to the system bus 1622 via an interface, such as output interface 1650. In addition to a monitor, computers can also include other peripheral output devices such as speakers and a printer, which may be connected through output interface 1650.

The computer 1610 may operate in a networked or distributed environment using logical connections to one or more other remote computers, such as remote computer 1670. The remote computer 1670 may be a personal computer, a server, a router, a network PC, a peer device or other common network node, or any other remote media consumption or transmission device, and may include any or all of the elements described above relative to the computer 1610. The logical connections depicted in FIG. 16 include a network 1672, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A list system, comprising:
a list component, associated with a portal, configured to maintain a set of items in a list associated with a first user;
an interface component configured to obtain data related to an item for inclusion in the set of items from at least one source, wherein the list component is further configured to locate the item in the portal based at least in part on the data; and
an origin component configured to append source data to the item that identifies the at least one source from which the data related to the item was obtained.

2. The system of claim 1, wherein the at least one source includes at least one of a catalogue associated with the portal, or a second user.

3. The system of claim 2, wherein the second user is a friend of the first user.

4. The system of claim 1, wherein the at least one source is not associated with the portal.

5. The system of claim 4, wherein the at least one source includes at least one of a disparate portal, a social networking website, a search engine, an affiliate website, a barcode, a data matrix, an online advertisement, a photograph, a user device, or an offline advertisement.

6. The system of claim 4, wherein the list component is further configured to locate the item in a catalogue associated with the portal, and maintain the item in the list associated with the first user with a reference to the catalogue.

7. The system of claim 1, wherein the interface component is further configured to enable distribution of the list associated with the first user to at least one of at least one other user, or at least one destination not associated with the portal.

8. The system of claim 7, wherein the at least one destination includes at least one of a social networking website, or an affiliate website.

9. The system of claim 1, further comprising a tag component configured to enable a user to append a description to the item.

10. The system of claim 1, wherein at least one of the list component, the interface component, or the origin component are included in a software application.

11. The system of claim 1, wherein the software application is configured to utilize one or more features of a device on which the software application is executed.

12. The system of claim 11, wherein the features include at least one of a camera, a bar code scanner, a touch screen, or a microphone.

13. The system of claim 1, wherein the list can be sorted based on at least one of date added, alphabetically, a source of origin, or data purchased.

14. A method, comprising:
obtaining information related to an item from at least one source;
correlating the information related to the item to an item reference associated with a portal;
attaching an identifier of the at least one source from which the information was obtained to the item reference; and
storing the item reference in a list associated with a first user.

15. The method of claim 14, wherein the obtaining the information related to the item comprises obtaining the information related to the item from at least one of a catalogue associated with the portal, or a second user.

16. The method of claim 14, wherein the obtaining the information related to the item comprises obtaining the information related to the item from a friend of the user.

17. The method of claim 14, wherein the obtaining the information related to the item comprises obtaining the information from at least one source not associated with the portal.

18. The method of claim 17, wherein the obtaining the information from the at least one source not associated with the portal comprises obtaining the information from at least one of a disparate portal, a social network website, a search engine, an affiliate, a barcode, a data matrix, an online advertisement, a photograph, a user device, or an offline advertisement.

19. The method of claim 14, further comprising distributing the list associated with the first user, based at least in part on a set of permissions, to at least one of another user, a social network, or an affiliate.

20. The method of claim 14, further comprising attaching an item description provided by the first user to the item reference.

21. The method of claim 14, further comprising receiving a request to access the list, and granting the request based at least in part on a set of permissions.

22. A computer readable storage medium comprising computer executable instructions that, in response to execution by a computing system, cause the computing system to perform operations, comprising:
obtaining information related to an item from at least one source;
locating an item reference for the item associated with a portal based at least in part on the information;
adding the item reference to a list associated with a first user; and
maintaining an identifier of the at least one source from which the information was obtained with the item reference.

23. The computer readable storage medium of claim 22, wherein the obtaining the information related to the item includes obtaining the information related to the item from at least one of a catalogue associated with the portal, or a second user.

24. The computer readable storage medium of claim 22, wherein the obtaining the information related to the item includes obtaining the information related to the item from a friend of the user.

25. The computer readable storage medium of claim 22, wherein the obtaining the information related to the item includes obtaining the information from at least one source not associated with the portal.

26. The computer readable storage medium of claim 22, wherein the obtaining the information from at least one source not associated with the portal comprises obtaining the information from at least one of a disparate portal, a social network website, a search engine, an affiliate, a barcode, a data matrix, an online advertisement, a photograph, a user device, or an offline advertisement.

27. The computer readable storage medium of claim 22, the operations further comprising distributing the list associated with the first user to at least one of at least one other user, a social network, or an affiliate based at least in part on a set of permissions.

28. The computer readable storage medium of claim 22, the operations further comprising attaching an item description provided by the first user to the item reference.

29. A system, comprising:
means for obtaining information related to an item from at least one source;
means for locating an item reference for the item associated with a portal based at least in part on the information;
means for adding the item reference to a list associated with a first user; and
means for maintaining an identifier of the at least one source from which the information was obtained with the item reference.

30. A device, comprising:
a capture component configured to obtain information related to an item;
a source component configured to identify a source of the information obtained;
an identification component configured to obtain a reference for the item with relation to a portal based at least in part on the information; and
an update component configured to enable a user to add the reference for the item to a list associated with the portal.

31. The device of claim 30, wherein the capture component is further configured to utilize at least one of a camera, a bar code scanner, a keypad, a touch screen, or a microphone associated with the device to obtain the information related to the item.

32. The device of claim 30, further comprising a display component configured to display the reference for the item with relation to the portal.

33. The device of claim 30, wherein the information includes at least one of a barcode, a data matrix, a photograph, or a user input.

34. A method, comprising:
acquiring data related to an item;
identifying a source of the data acquired;
obtaining an item link based on the data, wherein the item link references a portal; and
instructing the portal to add the item link to a list associated with the portal.

35. The method of claim 34, wherein acquiring the data related to the item comprises acquiring the data via at least one of a camera, a bar code scanner, a keypad, a touch screen, or a microphone associated with the device.

36. The method of claim 34, further comprising obtaining a user instruction regarding adding the item link to the list associated with the portal.

37. The method of claim 34, further comprising displaying information included in the item link associated with the portal.

38. The method of claim of claim 34, wherein acquiring the data related to the item comprises acquiring at least one at least one of a barcode, a data matrix, a photograph, or a user input.
